(19) United States
(12) Patent Application Publication
(10) Pub. No.: US 2020/0339168 A1
(43) Pub. Date: Oct. 29, 2020

(54) CONTROL SYSTEM FOR SIGNALS AT RAILROAD GRADE CROSSING

(71) Applicant: AUTO TRUCK GROUP, LLC, Bartlett, IL (US)

(72) Inventor: Patrick William McMahon, Streamwood, IL (US)

(73) Assignee: AUTO TRUCK GROUP, LLC, Bartlett, IL (US)

(21) Appl. No.: 16/855,494

(22) Filed: Apr. 22, 2020

Related U.S. Application Data
(60) Provisional application No. 62/840,065, filed on Apr. 29, 2019.

(51) Int. Cl. B61L 1/14; B61L 29/30; B61L 29/22; B60F 1/04

(52) U.S. Cl. CPC B61L 1/14; B60F 1/04; B61L 29/22; B61L 29/30

(57) ABSTRACT

An improved safety system used to determine the present position of road vehicles with rubber tires that are outfitted with railgear to be able to ride on railroad tracks that provides data to control signals, such as flashing lights, and crossing gates at railroad grade crossings in order to prevent accidents with vehicles or persons.

### CROSS REFERENCE TO RELATED APPLICATION

This application claims priority from U.S. Provisional Application No. 62/665,575 filed on May 2, 2018, U.S. Utility patent application Ser. No. 16/394,181 filed on Apr. 25, 2019, and U.S. Provisional Application No. 62/840,065 filed on Apr. 29, 2019.

### FIELD OF THE INVENTION

The instant invention relates to safety systems that determine the then present position of cars having railgear riding on railroad tracks that are critical in providing data to control signals, such as flashing lights, and crossing gates at railroad grade crossings in order to prevent accidents with vehicles or persons crossing said tracks at said grade crossing.

### BACKGROUND OF THE INVENTION

Railgear is used on cars, known as railcars, and is also the name for a group of devices that allow other cars, such as road vehicles with rubber tires, to travel on railroad tracks. When cars ride on railroad tracks, electrical continuity between the two rails can be allowed or insulated in order to trigger crossing gates and determine position on the track. Shunts are a part of the electro-mechanical system that allow continuity to be turned on and off by completing the circuit between the track and the wheels of a railcar or another vehicle outfitted with railgear, or breaking that circuit. Since such wheels are spinning, a system must be put in place to allow for the completion of an electrical circuit with a spinning conductor, that is, with a spinning rail wheel.

### SUMMARY OF THE INVENTION

Railgear are metal wheels used on railcars and are also retractable railroad track compatible guide wheels that can be attached to the body of a road vehicle having rubber automobile or truck tires that can be lowered into place so that the road vehicle can travel safely on railroad tracks and not fall off the tracks. For either type of car outfitted with metal railgear, electrical continuity between the two rails can be allowed or insulated in order to trigger crossing gates and determine position on the track. Shunts are a part of the electro-mechanical system that allows continuity to be turned on and off by completing the circuit between the track and the railgear, or breaking that circuit. Since such wheels are spinning, a system must be put in place to allow for the completion an electrical circuit with a spinning conductor, that is, with a spinning rail wheel.

An example of a prior art system that is used to complete an electrical circuit with a spinning rail wheel on a railcar is shown in FIGS. 1a, 1b, and 1c. FIG. 1a shows a conductive metal wire brush 100. The wire brush is in contact with, by riding on, the rail wheel outer edge 101 as shown in FIGS. 1b and 1c as the wheel spins as the rail car rides the tracks. The problem with the prior art system shown in these figures is that the constant contact between the wire brush 100 and the outside edge of the rail wheel 101 causes both part to wear more quickly than were the system not in place, with the result that the brush and the rail wheel require replacement more quickly than would otherwise be the case.

An example of a road vehicle, in this case a pickup truck, outfitted with railgear for riding on railroad track is shown in FIG. 1d in which truck 200 having rubber tires 201 is riding on railroad track 202 by using metal railgear 203 that are adapted to ride safely on the rails of said track 202.

The invention described herein solves the problem of frequent replacement of brushes and rail wheels by utilizing a contact shoe that rides on the inside surface of the rail wheel hub to make an electrical contact through spinning components in contact with the rail. A wire is connected to the stationary shunt contact shoe that allows control of connectivity allowing the shunt components to be protected by the rail wheel, eliminating wear on the outer surface of the rail wheel and providing a reliable connection. The contact shoe is the wear/replacement part which is significantly less expensive than the parts used in previous designs.

### BRIEF DESCRIPTION OF THE DRAWINGS

FIGS. 1a, 1b, and 1c illustrate the prior art use of wire brushes to complete an electrical circuit between a spinning rail wheel and a control system for safety at railroad grade crossings.

FIG. 1d is a side view of a pickup truck outfitted with railgear for riding the shown railroad track.

FIG. 2 is a perspective view of the shunt assembly of the present invention.

FIG. 3 is a perspective view of an entire assembly for a rail wheel of the present invention.

FIG. 4 is a perspective view of a shunt assembly of the present invention.

FIG. 5a shows the preferred embodiment of a conducive contact shoe of the present invention.

FIGS. 5b, 5c, and 5d show alternate embodiments of a conducive contact shore of the present invention.

### DETAILED DESCRIPTION OF THE INVENTION

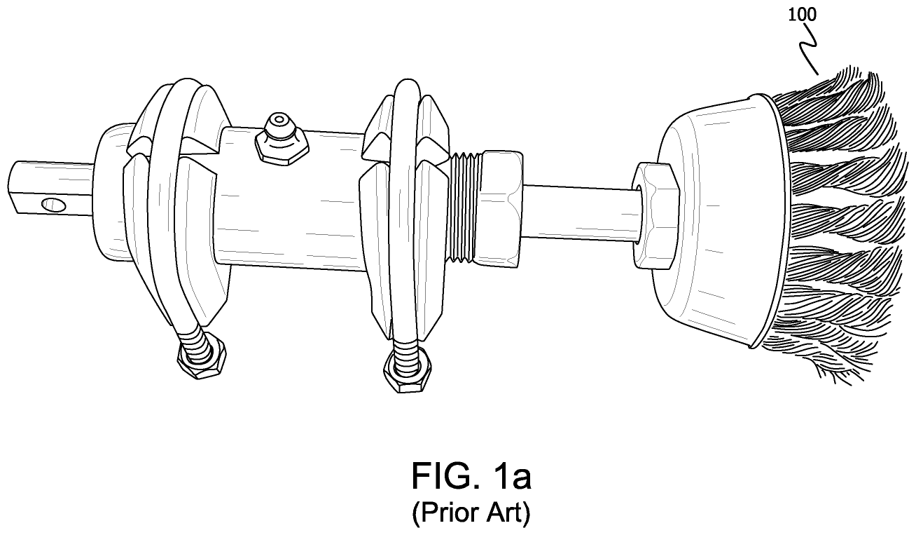

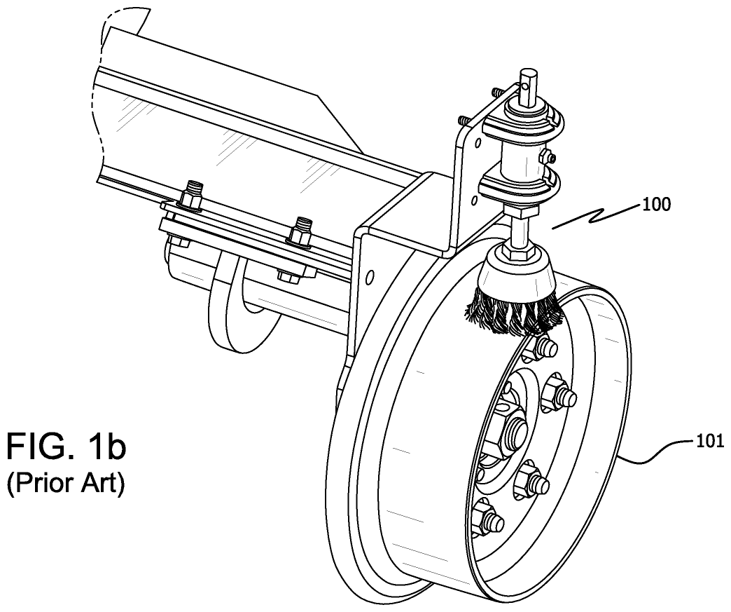

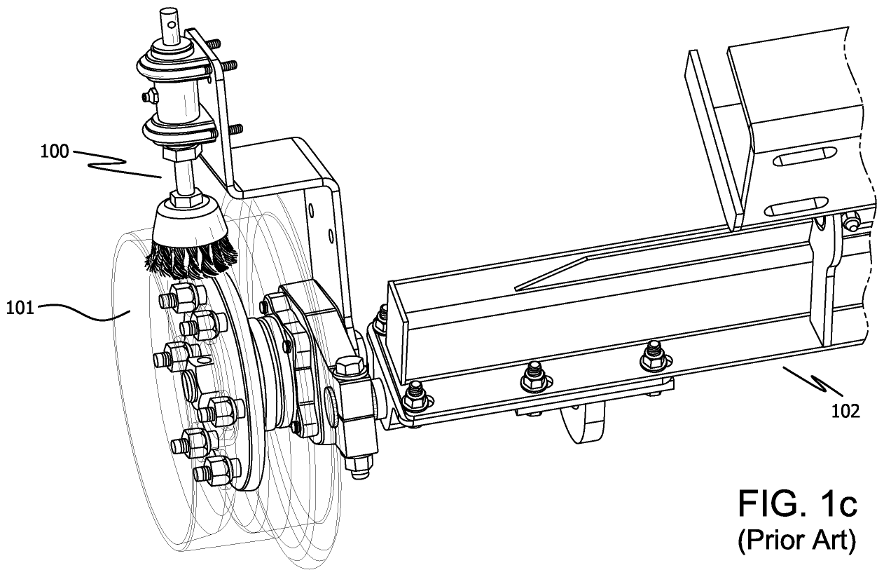

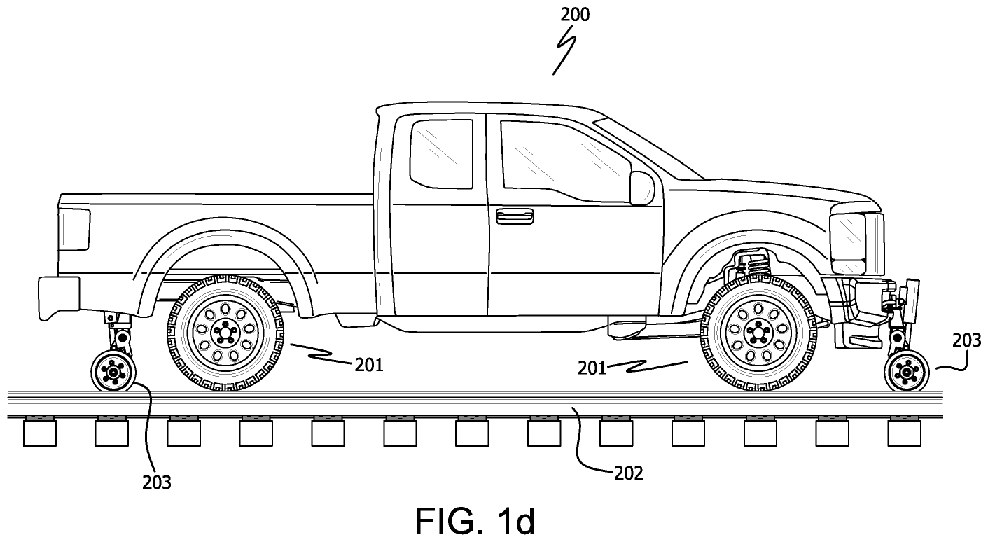

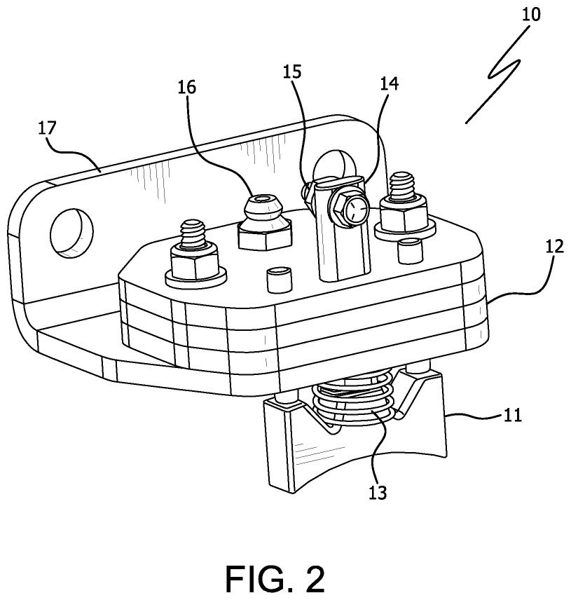

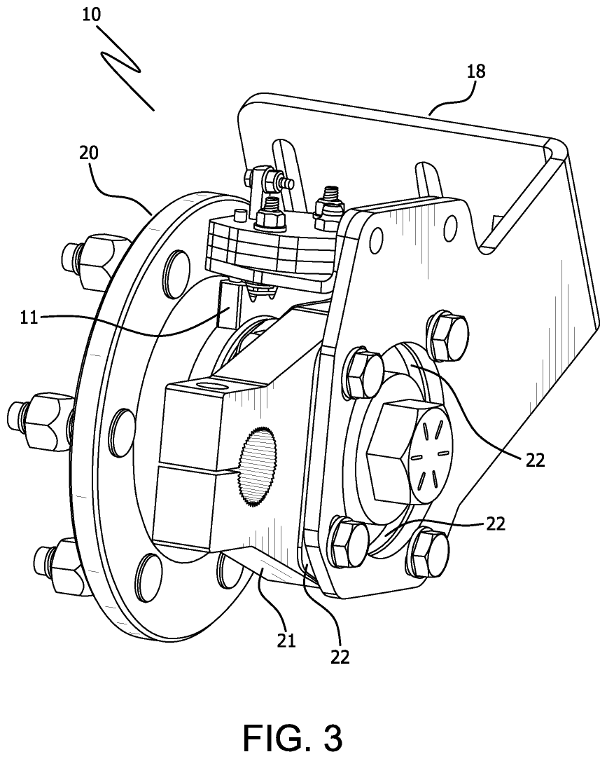

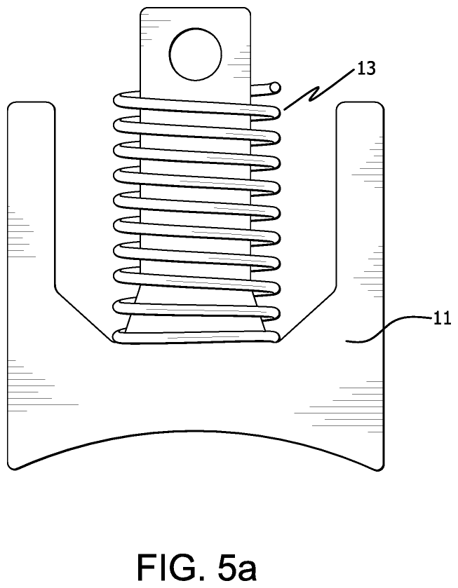

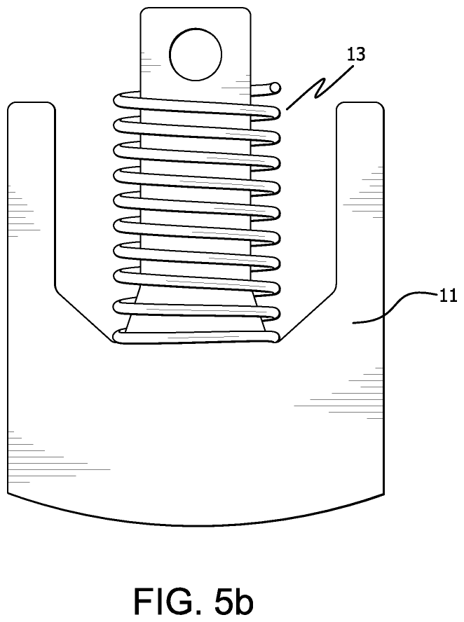

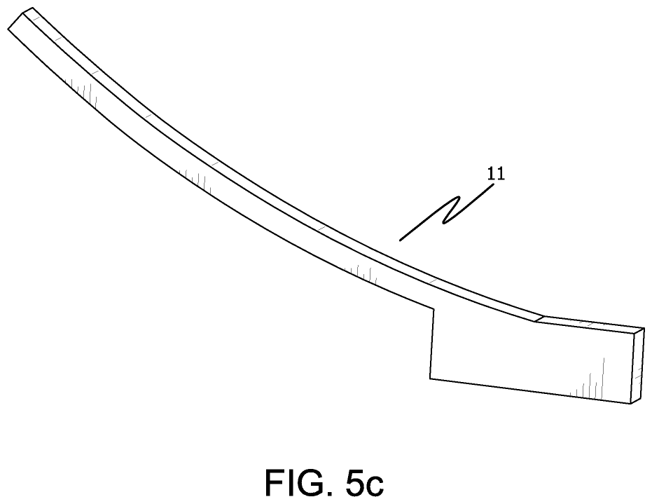

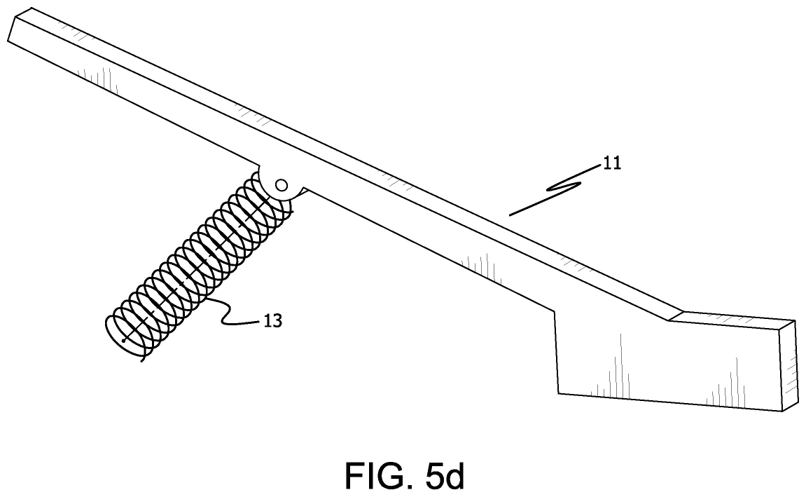

FIG. 2 is a perspective view of the shunt assembly 10 of the instant invention. Conductive contact shoe 11 having a concave base (as shown in FIG. 2 as the preferred embodiment, and also in FIG. 5a) is connected through grease housing plates 12 and is biased with coil spring 13 to maintain contact pressure on the hub 20 (as shown in FIG. 3) of the train wheel 203 as shown in FIG. 1d. Contact shoe 11 extends through plates 12 with a distal end 14 having a fastener set 15 in the form of a nut and bolt extending through said distal end 14. Grease fitting 16 is used to lubricate housing plates 12 and mounting plate 17 is used to attach shunt assembly 10 to rail sweep mounting bracket 18 as shown in FIG. 3.

FIG. 3 is a perspective view of the entire assembly for a rail wheel 203 as a part of the rail gear. FIG. 3 shows rail wheel hub 20 of wheel 203 on which contact shoe 11 rides. Conductive contact shoe 11 in the preferred embodiment is manufactured from cast 304L stainless steel, a relatively soft conductive material so as to minimize wear on hub 20. Wheel arm 21 connects wheel hub assembly 20 to rail gear 203 by white plastic insulators 22 that electrically insulate wheel hub assembly 20 from rail gear 203 so that the sole electrical path in the system is through shunt assembly 10.

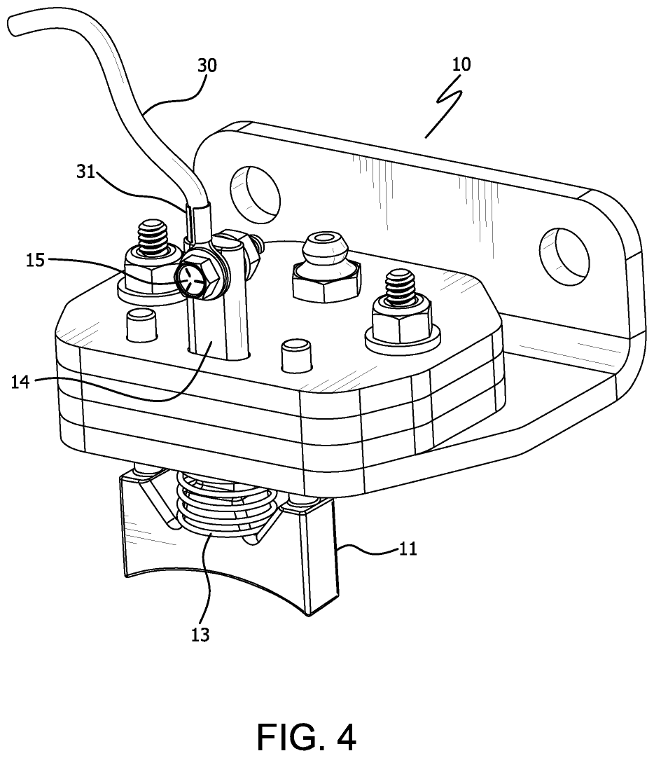

FIG. 4 is a perspective view of shunt assembly 10 showing wire 30 connected by eye ring 31 that is attached to fastener set 15 on distal end 14 of contact shoe 11 completing the electrical connection from electrified track 202 through the rail wheel 203 riding on track 202 through conductive contact shoe 11 to wire 30 which forms a shunt to complete the electrical circuit to control the gate crossing signals and gates.

FIG. 5a shows the preferred embodiment of the conducive contact shoe 11, in its concave form, with coil spring 13. FIGS. 5b, 5c, and 5d show alternate embodiments of contact shoe 11 and spring 13, which alternate embodiments are to be construed to be covered by this disclosure.

What is claimed is:

1. In a system for providing safety signals at grade crossings of electrified railroad track using a shunt assembly installed on a road vehicle having railgear for riding on said railroad track to complete an electrical circuit between a rail wheel of said vehicle and said track, the improvement comprising:
a conductive contact shoe; and
a spring,
whereby the position of said contact shoe is biased by said spring so as to be in continuous contact with said rail wheel riding on said track in order to complete said electrical circuit.

2. The improvement of claim 1 in which said shoe contacts the hub of said rail wheel.

3. The improvement of claim 1 or claim 2 in which the base of said conductive contact shoe is concave in form.

4. The improvement of claim 1 or claim 2 in which said conductive contact shoe is manufactured using cast 304L stainless steel.

5. The improvement of claim 1 further comprising:
a rail sweep mounting bracket connected to the undercarriage of said vehicle;
a wheel arm connected to said bracket;
a wheel hub assembly connected to said wheel arm;
rail gear having a hub connected to said wheel hub assembly; and
housing plates connected to said mounting bracket,
whereby said conductive contact shoe contacts said hub and is connected to said housing plates and said spring is positioned between said contact shoe and said housing plates.

6. A road vehicle shunt assembly for use in a control system for signals at electrified railroad track grade crossings comprising:
a rail sweep mounting bracket connected to the undercarriage of said vehicle riding on said railroad track;
a wheel arm connected to said bracket;
a wheel hub assembly connected to said wheel arm;
rail gear for said vehicle having a hub connected to said wheel hub assembly;
housing plates connected to said mounting bracket;
a conductive contact shoe connected to said housing plates; and
a spring positioned between said contact shoe and said housing plates,
whereby said spring acts to bias the position of said contact shoe with respect to said wheel hub so that said contact shoe is in continuous contact with said wheel hub.

7. The shunt assembly of claim 6 in which the base of said conductive contact shoe is concave in form.

8. The shunt assembly of claim 6 in which said conductive contact shoe is manufactured using cast 304L stainless steel.

9. The shunt assembly of claim 6 in which the base of said conductive contact shoe is of a form selected from the group of forms comprising: a concave base and a convex base.
